(19) United States
(12) Patent Application Publication
(10) Pub. No.: US 2026/0169338 A1
(43) Pub. Date: Jun. 18, 2026

(54) ELECTROCHROMIC ELEMENT AND DISPLAY DEVICE

(71) Applicant: SAMSUNG ELECTRONICS CO., LTD., Suwon-si (KR)

(72) Inventors: Atsuhito MURAI, Yokohama-shi (JP); Takashige FUJIMORI, Yokohama-shi (JP); Tatsuhiro SUWA, Yokohama-shi (JP)

(73) Assignee: SAMSUNG ELECTRONICS CO., LTD., Suwon-si (KR)

(21) Appl. No.: 19/425,133

(22) Filed: Dec. 18, 2025

Related U.S. Application Data
(63) Continuation of application No. PCT/KR2024/010038, filed on Jul. 12, 2024.

(30) Foreign Application Priority Data
Jul. 13, 2023 (JP) 2023-114948

(51) Int. Cl. G02F 1/155; G02F 1/1506; G02F 1/157; G02F 1/163

(52) U.S. Cl. CPC G02F 1/155; G02F 1/1506; G02F 1/157; G02F 1/163

(57) ABSTRACT

An electrochromic device includes: a first electrode including a first conductive area and a first non-conductive area, the first electrode being connected to a first electric potential; a second electrode opposite to the first electrode, and the second electrode including a second conductive area having an area ratio greater than an area ratio of the first conductive area in the first electrode; and an electrolyte layer between the first electrode and the second electrode, and including an electrochromic material.

### CROSS-REFERENCE TO RELATED APPLICATIONS

This application is a continuation of International Application No. PCT/KR2024/010038, filed on Jul. 12, 2024, which is based on and claims priority to Japanese Patent Application No. 2023-114948, filed on Jul. 13, 2023, in the Japanese Patent Office, the disclosures of which are incorporated by reference herein in their entireties.

### BACKGROUND

### 1. Field

The disclosure relates to an electrochromic element and a display device including the electrochromic element.

### 2. Description of Related art

An electrochromic element may include, for example, an electrolyte layer including an electrochromic material such as silver (Ag) between a pair of electrodes. In this electrochromic element, a light-shielding state and a light-transmissive state are switched by controlling a voltage applied between the pair of electrodes.

For example, during the switching from the light-transmissive state to the light-shielding state, silver ions in the electrolyte layer are reduced, and silver is deposited on a surface of the electrode. During the switching from the light-shielding state to the light-transmissive state, the silver deposited on the electrode surface is dissolved into the electrolyte layer.

In such an electrochromic element, the time required for switching from the light-transmissive state to the light-shielding state tends to be shorter than the time required for switching from the light-shielding state to the light-transmissive state.

### SUMMARY

Provided are an electrochromic element that may shorten the time required for switching from the light-shielding state to the light-transmissive state, and a display device using the same.

According to an aspect of the disclosure, an electrochromic element may include: a first electrode including a first electrically conductive area and at least one first electrically non-conductive area, the first electrode being connected to a first electric potential; a second electrode opposite to the first electrode, the second electrode comprising a second electrically conductive area having an area ratio greater than an area ratio of the first electrically conductive area in the first electrode; and an electrolyte layer between the first electrode and the second electrode, the electrolyte layer comprising an electrochromic material.

The second electrode may further include a second electrically non-conductive area and is connected to a second electric potential.

The at least one first electrically non-conductive area may include a plurality of first electrically non-conductive areas arranged in a certain pattern on the first electrode.

The first electrode may include a first transparent conductive layer, and the second electrode may include a second transparent conductive layer.

The first electrode may further include an insulating layer between the first transparent conductive layer and the electrolyte layer and arranged in the at least one first electrically non-conductive area.

The first transparent conductive layer may have an opening in the at least one first electrically non-conductive area.

The first electrode may further include a first low-resistance conductive layer, and the first low-resistance conductive layer may be on the first transparent conductive layer and may have a lower resistivity than the first transparent conductive layer.

The first low-resistance conductive layer may be on at least a portion of the first electrically conductive area.

The second electrode may further include a second low-resistance conductive layer, and the second low-resistance conductive layer may be on the second transparent conductive layer and may have a lower resistivity than the second transparent conductive layer, and at least a portion of the second low-resistance conductive layer may be at a position opposite to the first low-resistance conductive layer.

At least one of the first transparent conductive layer and the second transparent conductive layer may be a continuous layer.

The electrochromic material may be configured to switch between a light-shielding state, in which the electrochromic material is deposited on a surface of the second electrode, and a light-transmissive state, in which the electrochromic material is dissolved in the electrolyte layer.

The electrochromic element may further include: a voltage applicator configured to apply a voltage between the first electrode and the second electrode to switch between the light-shielding state and the light-transmissive state.

The voltage applicator may be configured to apply the voltage having a same magnitude and opposite polarities when switching from the light-shielding state to the light-transmissive state and when switching from the light-transmissive state to the light-shielding state.

In another embodiment, a display device may include: an electrochromic element including: a first electrode including a first electrically conductive area and at least one first electrically non-conductive area, the first electrode being connected to a first electric potential; a second electrode opposite to the first electrode, the second electrode including a second electrically conductive area having an area ratio higher than an area ratio of the first electrically conductive area in the first electrode; and an electrolyte layer between the first electrode and the second electrode, the electrolyte layer comprising an electrochromic material; and a transparent display on the electrochromic element and comprising a light-transmissive area and a light-shielding area.

At least a portion of the first electrically conductive area may be at a position overlapping the light-shielding area.

The electrochromic element may be configured to switch the transparent display between a high-contrast display mode and a high-transmittance display mode.

The display device may further include a voltage applicator configured to adjust the electric potential difference between the first electrode and the second electrode.

The second electrode may further include a second electrically non-conductive area and is connected to a second electric potential.

A plurality of first electrically non-conductive areas may be arranged in a certain pattern on the first electrode.

In another embodiment, a method of controlling an electrochromic element may include: applying a reduction voltage between a first electrode and a second electrode of the electrochromic element such that an electrochromic material is deposited on a surface of the second electrode o have a light-shielding state; and applying a oxidation voltage between the first electrode and the second electrode of the electrochromic element to dissolve the electrochromic material to switch to a light-transmissive state.

In the electrochromic element and the display device according to one or more embodiments of the disclosure, the first electrode may have a first electrically non-conductive area. Accordingly, even when a relatively high voltage is applied between the first electrode and the second electrode during switching from the light-shielding state to the light-transmissive state, light transmittance may be maintained by the first electrically non-conductive area. Therefore, the time required for switching from the light-shielding state to the light-transmissive state may be shortened.

### BRIEF DESCRIPTION OF THE DRAWINGS

FIG. 1 is a cross-sectional view of a display device according to an embodiment of the disclosure;

FIG. 2 is a plan view of an example of a first electrode illustrated in FIG. 1;

FIG. 3 is a plan view illustrating another example of the first electrode illustrated in FIG. 2;

FIG. 4 is a plan view illustrating an example of a transparent display illustrated in FIG. 1;

FIG. 5A is a cross-sectional view illustrating an example of a no-voltage-applied state of the electrochromic element illustrated in FIG. 1;

FIG. 5B is a cross-sectional view illustrating an example of a light-shielding state of the electrochromic element illustrated in FIG. 1;

FIG. 5C is a cross-sectional view illustrating an example of a light-transmissive state of the electrochromic element illustrated in FIG. 1;

FIG. 6 is a view illustrating an example of a voltage applied to the electrochromic element illustrated in FIG. 1;

FIG. 7 is a view illustrating an example of a change in light transmittance of the electrochromic element illustrated in FIG. 1;

FIG. 8 is a cross-sectional view illustrating an example of a configuration of an electrochromic element according to a comparative example;

FIG. 9 is a view illustrating an example of a voltage applied to the electrochromic element illustrated in FIG. 8;

FIG. 10 is a cross-sectional view illustrating an example of a configuration of an electrochromic element according to another embodiment;

FIG. 11 is a plan view illustrating an example of a second electrode illustrated in FIG. 10;

FIG. 12 is a plan view illustrating another of the second electrode illustrated in FIG. 11;

FIG. 13 is a cross-sectional view illustrating an example of a configuration of an electrochromic element according to another embodiment;

FIG. 14 is a cross-sectional view illustrating another example of the configuration of the electrochromic element illustrated in FIG. 13;

FIG. 15 is a cross-sectional view illustrating another example of the configuration of the electrochromic element illustrated in FIG. 13;

FIG. 16 is a cross-sectional view illustrating an example of the configuration of the electrochromic element according to another embodiment;

FIG. 17 is a cross-sectional view illustrating another example of the configuration of the electrochromic element illustrated in FIG. 16;

FIG. 18 is a cross-sectional view illustrating another example of the configuration of the electrochromic element illustrated in FIG. 16;

FIG. 19 is a cross-sectional view illustrating another example of the configuration of the electrochromic element illustrated in FIG. 16;

FIG. 20 is a cross-sectional view illustrating another example of the configuration of the electrochromic element illustrated in FIG. 16; and

FIG. 21 is a cross-sectional view illustrating another example of the configuration of the electrochromic element illustrated in FIG. 16.

### DETAILED DESCRIPTION

Hereinafter, embodiments of the disclosure will be described in detail with reference to the accompanying drawings. In the drawings, the same reference numerals denote the same components, and the sizes of the respective components in the drawings may be exaggerated for clarity and convenience of explanation. The embodiments described below are merely illustrative, and various modifications may be made thereto.

In the following description, the terms “upper” or “on” may include not only being directly above in contact, but also being above without direct contact.

Unless otherwise clearly indicated by the context, expressions in the singular form include the plural form as well. When a certain part is described as “including” or “having” a certain component, it means that, unless otherwise expressly stated, the part may further include other components rather than excluding other components.

Furthermore, the use of the term “the” and similar referring terms may correspond to both the singular and the plural.

Unless steps constituting a method are explicitly described in a specific order, or otherwise stated to the contrary, the steps are performed in an appropriate order. The steps are not necessarily limited to the order in which they are described. All examples or terms are provided merely for illustrating the technical idea, and unless limited by the claims, the scope is not restricted by the examples or terms.

FIG. 1 illustrates an example configuration of a display device 100 according to an embodiment of the disclosure. FIG. 1 illustrates a cross-sectional configuration of the display device 100. The display device 100 may include an electrochromic element 1 and a transparent display 2. The transparent display 2 may be laminated on the electrochromic element 1.

The electrochromic element 1 may include, for example, a first substrate 10, a first electrode 20, an electrolyte layer 30, a second electrode 40, and a second substrate 50 in this order from a lower surface of the transparent display 2. The electrolyte layer 30 may include an electrochromic material. The electrochromic element 1 may further include a sealing material 60 and a voltage applicator 70. The sealing material 60 may seal the electrolyte layer 30 between the first substrate 10 and the second substrate 50. The voltage applicator 70 may apply a voltage between the first electrode 20 and the second electrode 40.

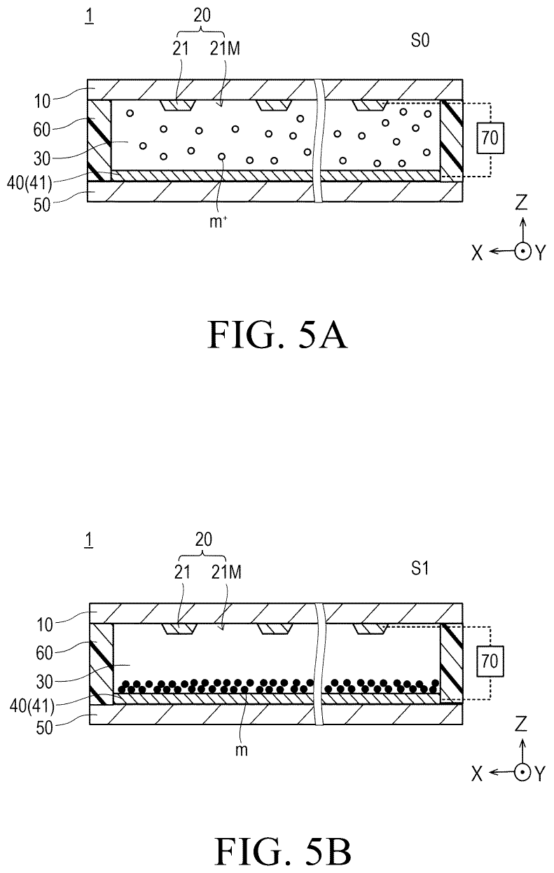

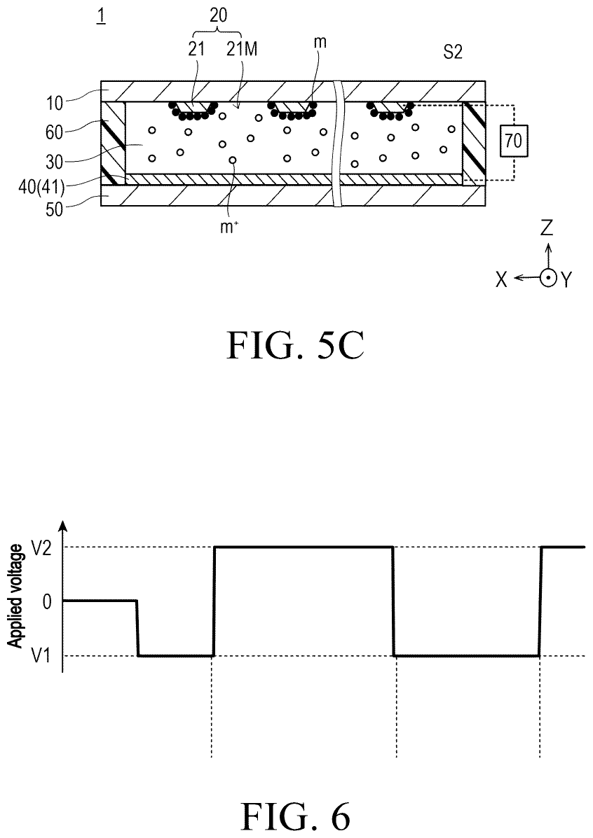

The electrochromic element 1 may have a light-shielding state and a light-transmissive state (e.g., the light-shielding state S1 of FIG. 5B and the light-transmissive state S2 of FIG. 5C) by controlling the voltage applied between the first electrode 20 and the second electrode 40. The light-shielding state and the light-transmissive state may be switchable. For example, during switching from the light-transmissive state to the light-shielding state, the electrochromic material dissolved in the electrolyte layer 30 may be deposited on a surface of the second electrode 40. For example, during switching from the light-shielding state to the light-transmissive state, the electrochromic material deposited on the surface of the second electrode 40 may be dissolved into the electrolyte layer 30. In an embodiment, the light-transmissive state S2 of FIG. 5C may include a state in which at least a portion of the electrochromic material may be deposited on a surface of the first electrode 20 (e.g., the first electrically conductive area 20C).

The transparent display 2 may include, for example, a transparent substrate 80, a driving substrate 91, and a light-emitting element 92 in this order from an upper surface of the electrochromic element 1. The transparent display 2 may include a plurality of driving substrates 91 and a plurality of light-emitting elements 92. The light-emitting elements 92 include, for example, red light-emitting elements 92R, green light-emitting elements 92G, and blue light-emitting elements 92B, and each of the plurality of driving substrates 91 may be provided with a red light-emitting element 92R, a green light-emitting element 92G, and a blue light-emitting element 92B. For example, a red light-emitting element 92R, a green light-emitting element 92G, and a blue light-emitting element 92B may be arranged in this order along a predetermined/certain direction. In the display device 100, an image may be displayed on a side of the transparent display 2.

In the following description, the lamination direction of the electrochromic element 1 and the transparent display 2 may be referred to as a third direction Z, the arrangement direction of the red light-emitting elements 92R, the green light-emitting elements 92G, and the blue light-emitting elements 92B may be referred to as a first direction X, and a direction orthogonal to both the first direction X and the third direction Z may be referred to as a second direction Y.

The first substrate 10 and the second substrate 50 may be disposed opposite to each other, for example, in the third direction Z. The first substrate 10 and the second substrate 50 may be, for example, transparent substrates having light-transmitting properties. The first substrate 10 and the second substrate 50 may be formed of, for example, glass or resin. The materials of the first substrate 10 and the second substrate 50 may be different from each other. The first substrate 10 and the second substrate 50 may have, for example, a rectangular planar shape (e.g., on the XY plane). The sizes of the first substrate 10 and the second substrate 50 of the XY plane may be, for example, substantially the same.

On a surface of the first substrate 10 opposite to the second substrate 50, a first electrode 20 may be disposed. Hereinafter, the surface of the first substrate 10 opposite to the second substrate 50 may also be referred to as the lower surface of the first substrate 10. For example, the first electrode 20 may be in contact with the lower surface of the first substrate 10. The electrochromic element 1 may include a single first electrode 20 connected to a first electric potential. Here, “electric potential” refers to a difference in voltage between two points required to move a unit electric charge from a reference point to a point in an electric field, and the “first electric potential” may refer to an electric potential when a predetermined/certain voltage is applied to the first electrode 20 based on an electric potential in a state where no voltage is applied. The first electrode 20 may include, for example, a transparent conductive layer 21 (e.g., first transparent conductive layer) having light-transmitting properties. The transparent conductive layer 21 may include, for example, at least one of indium tin oxide (ITO), indium zinc oxide (IZO), SnO₂, and ZnO. The first electrode 20 may include a single transparent conductive layer 21 that is not electrically divided. The transparent conductive layer 21 may have a laminated structure. Here, the expression “not electrically divided” means that, as illustrated in FIG. 5A, although the plurality of transparent conductive layers 21 are illustrated as separate structures, the transparent conductive layers 21 of FIG. 5A may be electrically connected to each other. For example, when a voltage is applied to the first electrode 20 of FIG. 5A, the transparent conductive layers 21 may have substantially the same electric potential.

In an embodiment, the first electrode 20 may have an electrically non-conductive area 20N (e.g., first electrically non-conductive area). The electrically non-conductive area 20N may be an area substantially without electrical conductivity. As will be described later in detail, even when a relatively high voltage is applied between the first electrode 20 and the second electrode 40 during switching the electrochromic element 1 from the light-shielding state to the light-transmissive state, deposition of the electrochromic material onto the electrically non-conductive area 20N may be suppressed. Therefore, at least in the electrically non-conductive area 20N, light transmittance may be maintained. An area of the first electrode 20 other than the electrically non-conductive area 20N may be an electrically conductive area 20C (e.g., first electrically conductive area).

The electrically non-conductive area 20N may be formed as, for example, an opening 21M in the transparent conductive layer 21. For example, the opening 21M may be selectively formed in the electrically non-conductive area 20N. In an embodiment, the opening 21M may refer to an area of the first electrode 20 that are surrounded by the transparent conductive layer 21 but in which no conductive material is disposed. In an embodiment, when a voltage is applied to the first electrode 20 and/or the transparent conductive layer 21 and the electrochromic material is deposited, the electrochromic material may not be substantially deposited in the electrically non-conductive area 20N or the opening 21M, and light transmittance may be maintained. The first electrode 20 may include, for example, a plurality of electrically non-conductive areas 20N (e.g., openings 21M), and the plurality of electrically non-conductive areas 20N may be arranged in a dispersed manner. For example, in the electrochromic element 1, a plurality of openings 21M may be formed in a predetermined/certain pattern in a single transparent conductive layer 21 formed on the lower surface of the first substrate 10. Thus, the plurality of electrically non-conductive areas 20N may be arranged in a dispersed manner.

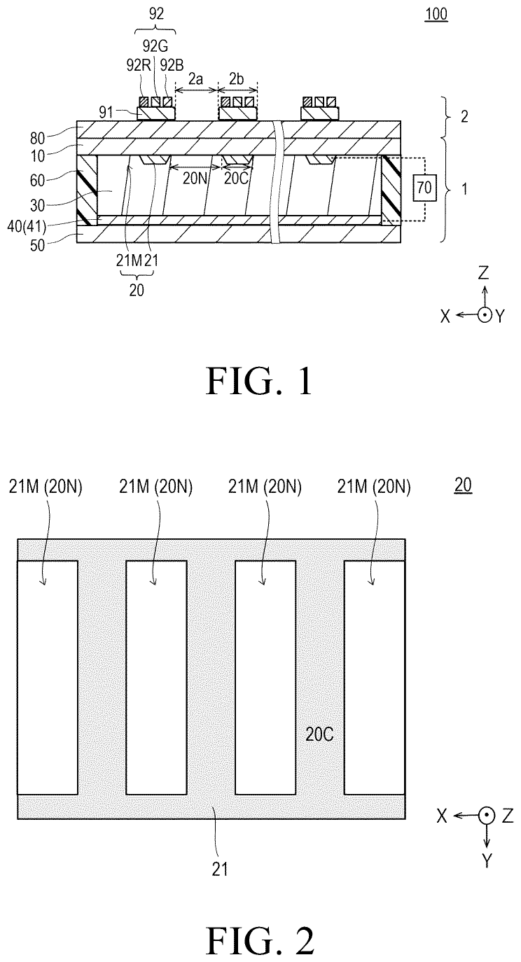

FIG. 2 illustrates an example of an arrangement of the plurality of openings 21M formed in the transparent conductive layer 21. The openings 21M may have, for example, a rectangular planar shape (e.g., on the XY plane) extending in the second direction Y. The plurality of openings 21M may be arranged side by side in the first direction X. For example, the plurality of openings 21M may be arranged in a stripe shape. The openings 21M may each have another planar shape such as an ellipse. The openings 21M may each have a rectangular planar shape extending in the first direction X, and the plurality of openings 21M may be arranged side by side in the second direction Y.

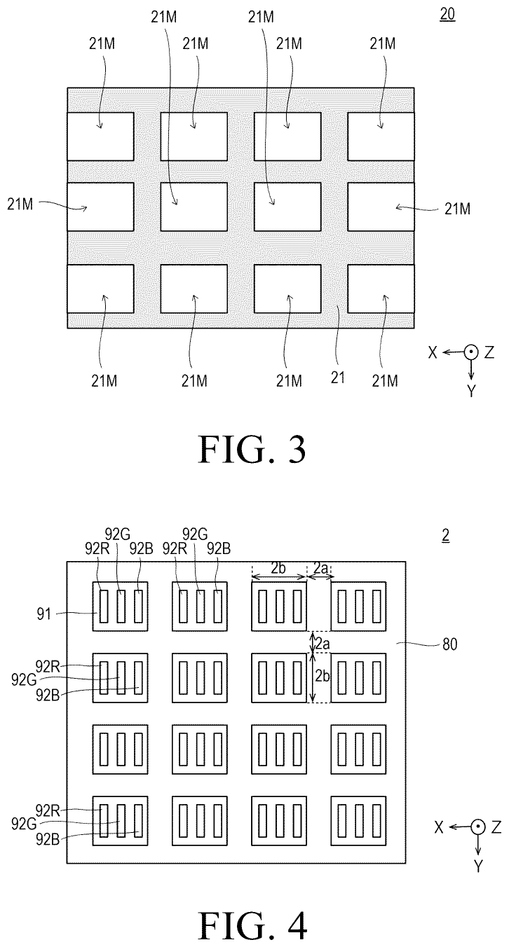

FIG. 3 illustrates another example of the arrangement of the plurality of openings 21M. The openings 21M may be arranged, for example, in a matrix shape. The openings 21M may each have, for example, a rectangular planar shape (e.g., on the XY plane) and may be arranged in a matrix shape in the first direction X and the second direction Y. In another example, the openings 21M may each have another planar shape such as a circle or a polygon.

The electrolyte layer 30 formed between the first electrode 20 and the second electrode 40 may include, for example, an electrolyte, an electrochromic material, a mediator, and a solvent. The electrolyte layer 30 may further include additives such as a thickener and a gelling polymer.

The electrolyte included in the electrolyte layer 30 may have a function of promoting oxidation and reduction or the like of the electrochromic material. The electrolyte may be a supporting electrolyte. As the electrolyte, for example, lithium salts, potassium salts, sodium salts, and the like may be used. The lithium salts may include, for example, lithium chloride (LiCl), lithium bromide (LiBr), lithium iodide (LiI), lithium tetrafluoroborate (LiBF₄), and lithium perchlorate (LiClO₄). The potassium salts may include potassium chloride (KCl), potassium bromide (KBr), and potassium iodide (KI). The sodium salts may include sodium chloride (NaCl), sodium bromide (NaBr), and sodium iodide (NaI). The electrolyte may contain bromine, and may include, for example, tetrabutylammonium bromide (TBABr).

The electrochromic material may be a substance that exhibits a reversible change in its optical properties through an electrochemical oxidation and reduction reaction. In the electrochromic material, deposition onto an electrode surface and dissolution into the electrolyte layer 30 may occur due to the electrochemical oxidation and reduction reactions. The electrochromic material may include, for example, a metallic element. For example, the electrochromic material may include one or more metallic elements selected from the group consisting of silver (Ag), bismuth (Bi), chromium (Cr), iron (Fe), cadmium (Cd), cobalt (Co), nickel (Ni), tin (Sn), lead (Pb), and copper (Cu). The electrochromic material may include, for example, silver, and may include silver nitrate (AgNO₃), silver perchlorate (AgClO₄), or silver bromide (AgBr).

The mediator may be a material capable of performing oxidation and reduction at a lower electrochemical energy than the electrochromic material. For example, the oxidized form of the mediator may frequently exchange electrons with the electrochromic material such as silver, thereby promoting dissolution of the electrochromic material into the electrolyte layer 30. As the mediator, a salt of copper (II) ion may be used. For example, copper chloride (CuCl₂), copper sulfate (CuSO₄), or copper bromide (CuBr₂) may be used.

The solvent may dissolve the electrolyte, the electrochromic material, and the mediator, and may keep them stable. As the solvent, for example, a polar solvent, an organic solvent, an ionic liquid, an ion-conductive polymer, or a polymer electrolyte may be used. As the solvent, for example, dimethyl sulfoxide (DMSO), propylene carbonate, N,N-dimethylformamide, tetrahydrofuran, acetonitrile, polyvinylsulfonic acid, polystyrene sulfonic acid, or polyacrylic acid may be used.

The second electrode 40 may be opposite to the first electrode 20 with the electrolyte layer 30 interposed therebetween. The second electrode 40 may be disposed on a surface of the second substrate 50 opposite to the first substrate 10. Hereinafter, the surface of the second substrate 50 opposite to the first substrate 10 may also be referred to as the upper surface of the second substrate 50. For example, the second electrode 40 may be in contact with the upper surface of the second substrate 50.

The electrochromic element 1 may include a single second electrode 40 connected to a second electric potential. Here, the “second electric potential” may refer to an electric potential when a predetermined/certain voltage is applied to the second electrode 40 based on an electric potential in a state where no voltage is applied. The second electrode 40 may include, for example, a transparent conductive layer 41 (e.g., second transparent conductive layer) having light-transmitting properties. The transparent conductive layer 41 may include, for example, at least one of ITO, IZO, SnO₂, and ZnO. The transparent conductive layer 41 may be made of the same material as, or of a different material from, the transparent conductive layer 21. The second electrode 40 may include a single transparent conductive layer 41 that is not electrically divided. The transparent conductive layer 41 may have a laminated structure. The transparent conductive layer 41 may be formed, for example, over an entire surface of the second substrate 50. For example, the transparent conductive layer 41 may be formed as a so-called beta film (or beta layer). The beta layer may refer, for example, to a continuous film (or continuous layer) that does not include an opening (e.g., the opening 21M of the first electrode 20). In an embodiment, the beta layer may refer to a film (or a layer) formed by sputtering, deposition, plating, or printing, and may have a substantially uniform thickness on a substrate (e.g., the second substrate 50). Here, the expression “substantially uniform thickness” may refer to a case where a thickness difference within an allowable tolerance is present in a portion of the beta layer. In an embodiment, a portion of the beta layer may be an electrically conductive area, and another portion may be an electrically non-conductive area. In an embodiment, the transparent conductive layer 41 and/or the second electrode 40 may be implemented as a beta layer including an electrically non-conductive area. In an embodiment, the entire area of the second electrode 40 may be configured as an electrically conductive area. For example, the second electrode 40 may have an electrically conductive area having an area ratio greater than an area ratio of the electrically conductive area 20C in the first electrode 20. For example, the first electrode 20 and the second electrode 40 may have substantially equal areas, and since the transparent conductive layer 21 of the first electrode 20 may include the electrically non-conductive area 20N and/or the opening 21M, the area ratio of the electrically conductive area 20C in the first electrode 20 may be smaller than the area ratio of the electrically conductive area (e.g., the transparent conductive layer 41) in the second electrode 40. The surface of the second electrode 40 (e.g., the surface opposite to the first electrode 20) is, for example, a flat surface.

The sealing material 60 may be disposed between the first substrate 10 and the second substrate 50. The sealing material 60 may be arranged in a frame shape along the peripheral edges of the first substrate 10 and the second substrate 50. The space surrounded by the first substrate 10, the second substrate 50, and the sealing material 60 may be filled with the electrolyte layer 30. The sealing material 60 may be formed of, for example, an ultraviolet-curable resin or a thermosetting resin.

The voltage applicator 70 may apply a voltage between the first electrode 20 and the second electrode 40. The voltage applicator 70 may include, for example, a power source electrically connected to each of the transparent conductive layer 21 and the transparent conductive layer 41. By applying a voltage between the first electrode 20 and the second electrode 40, the voltage applicator 70 may switch the electrochromic element 1 between the light-shielding state and the light-transmissive state.

FIG. 4 illustrates a planar configuration (e.g., on the XY plane) of a portion of the transparent display 2.

The transparent substrate 80 may be a substrate having light-transmitting properties. The transparent substrate 80 may be formed of, for example, glass, quartz, or resin. The transparent substrate 80 may have, for example, a rectangular planar shape.

The driving substrate 91 may be a substrate for driving the red light-emitting element 92R, the green light-emitting element 92G, and the blue light-emitting element 92B. A plurality of driving substrates 91 may be arranged in a matrix form on the transparent substrate 80. The driving substrates 91 may be disposed, for example, for respective pixels. The driving substrates 91 may include, for example, a base material and a wiring layer formed on the base material. The base material may be formed of, for example, glass or resin. The wiring layer may include, for example, a circuit pattern connected to the red light-emitting element 92R, the green light-emitting element 92G, and the blue light-emitting element 92B, and a thin layer transistor (TFT) and wires connected to the circuit pattern. The wiring layer may include another driving element instead of the TFT. In another example, the transparent display 2 may be driven by a passive matrix.

According to an embodiment, a portion of the transparent display 2 (e.g., the transparent substrate 80) may function as a light-shielding area due to the driving substrates 91 and/or the light-emitting elements 92. In an embodiment, at least a portion of the first electrically conductive area 20C may be disposed so as to overlap the light-shielding area of the transparent display 2. In an embodiment, the first electrically conductive area 20C may be disposed so as to substantially overlap the light-shielding area of the transparent display 2. In an embodiment, the light-shielding area of the transparent display 2 may substantially correspond to a light-emitting area in which the driving substrates 91 and/or the light-emitting elements 92 are arranged.

The red light-emitting element 92R, the green light-emitting element 92G, and the blue light-emitting element 92B disposed on each driving substrate 91 may be configured as, for example, micro light-emitting diodes (micro-LEDs), and may include, in this order from an upper surface of the driving substrate 91, an electrode and a semiconductor layer. The electrodes of the red light-emitting element 92R, the green light-emitting element 92G, and the blue light-emitting element 92B may be bonded, for example, to a circuit pattern of the driving substrates 91. Light in a red wavelength area may be emitted from the red light-emitting element 92R, light in a green wavelength area may be emitted from the green light-emitting element 92G, and light in a blue wavelength area may be emitted from the blue light-emitting element 92B. The semiconductor layers of the red light-emitting element 92R, the green light-emitting element 92G, and the blue light-emitting element 92B may include different semiconductor materials, or some or all of them may include the same semiconductor material.

The red light-emitting element 92R, the green light-emitting element 92G, and the blue light-emitting element 92B may have, for example, a rectangular planar shape (e.g., on the XY plane). A side of the rectangle may have, for example, a size of 1 μm to 100 μm. The red light-emitting element 92R, the green light-emitting element 92G, and the blue light-emitting element 92B may have, for example, a three-dimensional shape such as a substantially rectangular parallelepiped or a substantially cubic shape. In another example, the red light-emitting element 92R, the green light-emitting element 92G, and the blue light-emitting element 92B may have another planar shape such as a circle. The transparent display 2 may further include a color filter, a sealing substrate, and the like.

A light-transmissive area 2a and a plurality of light-shielding areas 2b may be formed in the transparent display 2. In the light-transmissive area 2a, light from the side of the electrochromic element 1 may pass through the transparent substrate 80 and may be emitted to a display surface of the display device 100. In the light-shielding areas 2b, transmission of the light from the side of the electrochromic element 1 may be inhibited by the driving substrates 91 and the light-emitting element 92. For example, the areas, in which the driving substrates 91 and the light-emitting elements 92 are disposed, may correspond to the light-shielding areas 2b. The light-shielding areas 2b may be arranged, for example, in a matrix shape (see, e.g., FIG. 4).

For example, the light-shielding areas 2b may be arranged, when viewed on a plane (e.g., on the XY plane) or in plan view, at positions at least partially overlapping the electrically conductive areas 20C of the first electrode 20. For example, the light-transmissive area 2a may be disposed, when viewed in a plane (or in plan view), at a position overlapping at least a portion of each of the electrically non-conductive areas 20N of the first electrode 20. Thus, when the electrochromic element 1 is in the light-transmissive state, light on the side of the electrochromic element 1 may be emitted to a display surface of the display device 100 through the electrically non-conductive areas 20N and the light-transmissive area 2a. Therefore, high light transmittance of the display device 100 may be maintained.

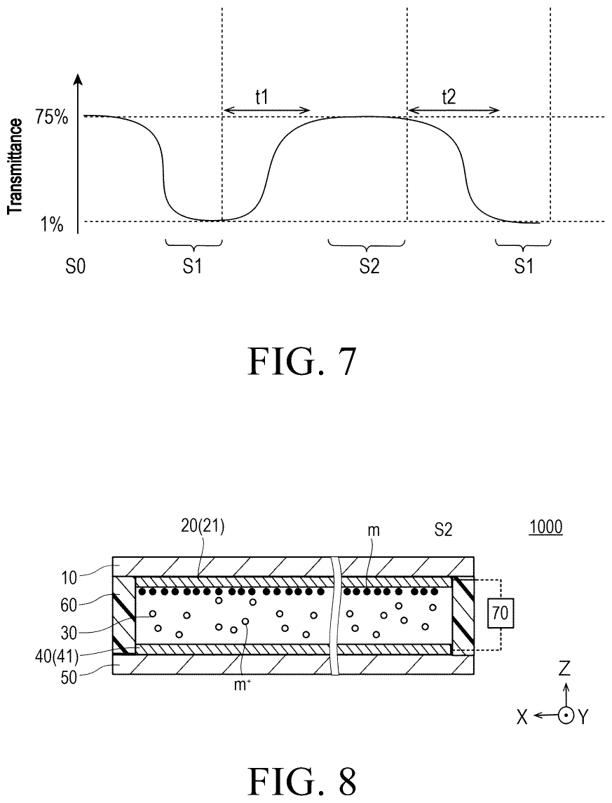

A method of driving the electrochromic element 1 will be described with reference to FIGS. 5A, 5B, and 5C, FIG. 6, and FIG. 7. FIGS. 5A, 5B, and 5C respectively illustrate a no-voltage-applied state (S0), a light-shielding state (S1), and a light-transmissive state (S2) of the electrochromic element 1. FIG. 6 illustrates an example of a voltage applied between the first electrode 20 and the second electrode 40 by the voltage applicator 70. FIG. 7 illustrates the light transmittance of the electrochromic element 1 when the voltage illustrated in FIG. 6 is applied.

When no voltage is applied between the first electrode 20 and the second electrode 40, e.g., in a no-voltage-applied state, the electrochromic element 1 may be in the no-voltage-applied state S0 (see, e.g., FIG. 5A). For example, the electrochromic material including metal ions m+, such as silver ions, may be dissolved in the electrolyte layer 30.

Next, when a reduction voltage V1 (see, e.g., FIG. 6) is applied between the first electrode 20 and the second electrode 40 such that the second electrode 40 may become a cathode, the metal ions m+ in the electrolyte layer 30 may be reduced, and a metal m, such as silver, may be deposited on the surface of the second electrode 40 (see, e.g., FIG. 5B). For example, the reduction voltage V1 may be a forward bias voltage or a negative voltage. Thus, the light transmittance of the electrochromic element 1 may decrease to about 1% (see, e.g., FIG. 7). For example, the electrochromic element 1 may enter the light-shielding state S1. In this light-shielding state S1, for example, the deposited metal m may reflect visible light, and a mirror surface may be formed on the surface of the second electrode 40.

Next, when a reduction voltage V1 and an oxidation voltage V2 (see, e.g., FIG. 6) are applied between the first electrode 20 and the second electrode 40, the metal m deposited on the surface of the second electrode 40 may be oxidized and become metal ions m+ (see, e.g., FIG. 5C). For example, the oxidation voltage V2 may be a reverse bias voltage or a positive voltage. Thus, the light transmittance of the electrochromic element 1 may increase to about 75% (see, e.g., FIG. 7). For example, the electrochromic element 1 may enter the light-transmissive state S2. For example, the absolute value of the oxidation voltage V2 may be substantially equal to the absolute value of the reduction voltage V1 (|V1|=|V2| or |V1| [symbol] |V2|). After applying the oxidation voltage V2 between the first electrode 20 and the second electrode 40, the time until the light transmittance of the electrochromic element 1 reaches about 75%, may be, for example, time t1.

When the oxidation voltage V2 is applied between the first electrode 20 and the second electrode 40, some of the metal ions m+ may be reduced at the surface of the first electrode 20, and the metal m may be deposited on the electrically conductive area 20C (e.g., the transparent conductive layer 21) of the first electrode 20. In an embodiment, the first electrode 20 may have the electrically non-conductive areas 20N. In the electrically non-conductive areas 20N, the reduction reaction of the metal ions m+ may not proceed, and the metal m may not be deposited. Therefore, light transmittance may be maintained in the electrically non-conductive areas 20N.

When the reduction voltage V1 (see, e.g., FIG. 6) is applied again to the electrochromic element 1 in the light-transmissive state S2, the metal ions m+ in the electrolyte layer 30 may be reduced, and the metal m may be deposited on the surface of the second electrode 40 (see, e.g., FIG. 5B). For example, the electrochromic element 1 returns to the light-shielding state S1. After applying the reduction voltage V1 between the first electrode 20 and the second electrode 40, the time until the light transmittance of the electrochromic element 1 reaches about 1% is, for example, time t2. For example, the times t1 and t2 may be substantially equal in length (t1=t2 or t1 [symbol] t2).

In the electrochromic element 1 and the display device 100 according to an embodiment, the first electrode 20 may have electrically non-conductive areas 20N. Accordingly, when switching from the light-shielding state S1 to the light-transmissive state S2, although a relatively larger oxidation voltage V2 is applied between the first electrode 20 and the second electrode 40, light transmittance may be maintained by the electrically non-conductive areas 20N. Therefore, the time t1 required to switch from the light-shielding state S1 to the light-transmissive state S2 may be shortened or reduced. Hereinafter, this operational effect will be described using a comparative example.

FIG. 8 illustrates an example of a cross-sectional configuration of an electrochromic element 1000 according to a comparative example. In the electrochromic element 1000, the first electrode 20 may not have an electrically non-conductive area (e.g., the electrically non-conductive areas 20N in FIG. 1). For example, the entire area of the first electrode 20 may be configured as an electrically conductive area. When an oxidation voltage V2 is applied between the first electrode 20 and the second electrode 40 of the electrochromic element 1000, the electrochromic element 1000 may enter the light-transmissive state S2. However, when the relatively larger oxidation voltage V2 is applied, metal m may tend to be deposited on the surface of the first electrode 20. Accordingly, there may be a concern that the light transmittance in the light-transmissive state S2 may be impaired due to the metal m deposited over the entire surface of the first electrode 20.

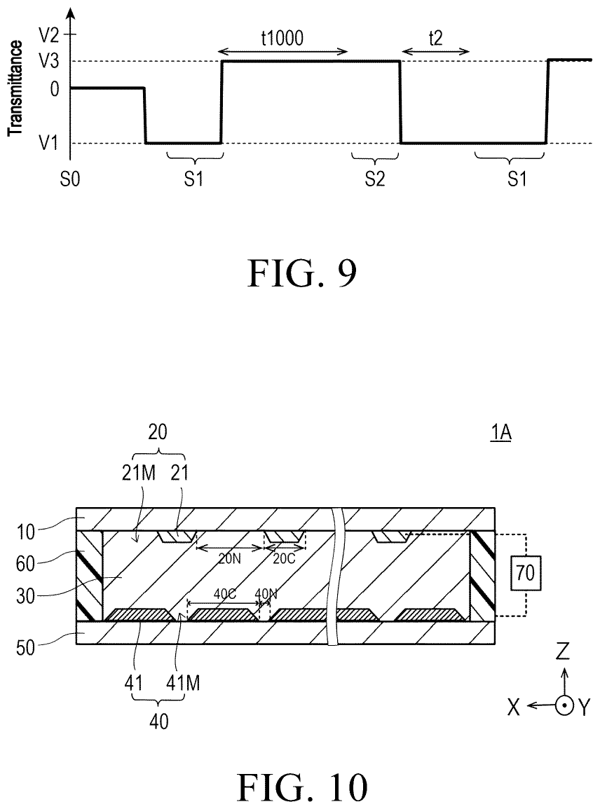

FIG. 9 illustrates an example of a voltage applied between the first electrode 20 and the second electrode 40 of the electrochromic element 1000. In the electrochromic element 1000, by applying an oxidation voltage V3 smaller than the oxidation voltage V2, deposition of the metal m on the surface of the first electrode 20 in the light-transmissive state S2 may be suppressed. For example, the light transmittance in the light-transmissive state S2 may be maintained. However, with the smaller oxidation voltage V3, the progress of the redox reaction may become slower compared to the larger oxidation voltage V2. Therefore, the time t1000 required for switching from the light-shielding state S1 to the light-transmissive state S2 may become longer than the time t2 required for switching from the light-transmissive state S2 to the light-shielding state S1.

In the electrochromic element 1 and the display device 100 of FIG. 1, the first electrode 20 may have the electrically non-conductive areas 20N. Accordingly, when switching from the light-shielding state S1 to the light-transmissive state S2, although an oxidation voltage V2 larger than the oxidation voltage V3 is applied, light transmittance may be maintained by the electrically non-conductive areas 20N. The magnitude of the oxidation voltage V2 is, for example, substantially equal to the magnitude of the reduction voltage V1 applied when switching from the light-transmissive state S2 to the light-shielding state S1. In an embodiment, the oxidation voltage V2 may correspond to a reverse voltage of the reduction voltage V1. Therefore, the time t1 required to switch from the light-shielding state S1 to the light-transmissive state S2 may be shortened compared to the time t1000. The time t1 is, for example, substantially equal in length to the time t2 required for switching from the light-transmissive state S2 to the light-shielding state S1.

For example, a plurality of electrically non-conductive areas 20N may be arranged in a predetermined/certain pattern in the first electrode 20. Accordingly, when the electrochromic element 1 is in the light-transmissive state S2, the film stress of the metal m deposited on the electrically conductive area 20C may be relaxed. Thus, film peeling of the metal m on the surface of the first electrode 20 may be less likely to occur, and light transmittance may be maintained more stably.

When the electrochromic element 1 is set to the light-transmissive state S2 and an image is displayed on the transparent display 2, the image may be displayed with high light transmittance. When the electrochromic element 1 is set to the light-shielding state S1 and an image is displayed on the transparent display 2, the image may be displayed with high contrast. In the display device 100 including the electrochromic element 1 and the transparent display 2, the image may be displayed with a high degree of freedom by controlling the light transmittance of the electrochromic element 1.

Hereinafter, modifications of the electrochromic element 1 according to the above embodiment will be described. Hereinafter, in order to avoid redundancy in the description, detailed explanation will be omitted for configurations similar to those of the electrochromic element 1 of the above embodiment.

FIG. 10 illustrates an example of a cross-sectional configuration (e.g., XZ cross section) of an electrochromic element (e.g., electrochromic element 1A) according to another embodiment. FIG. 10 corresponds to FIG. 1 illustrating the electrochromic element 1 of the above embodiment. In this electrochromic element 1A, the first electrode 20 may have an electrically non-conductive area 20N, and the second electrode 40 may have an electrically non-conductive area 40N (e.g., second electrically non-conductive area). Except for this aspect, the electrochromic element 1A according to another embodiment may have the same configuration as the electrochromic element 1 described in the above embodiment.

The electrically non-conductive area 40N may be formed, for example, as an opening 41M in the transparent conductive layer 41. For example, the opening 41M may be selectively formed in the electrically non-conductive area 40N. The second electrode 40 may include, for example, a plurality of electrically non-conductive areas 40N, and the plurality of electrically non-conductive areas 40N may be arranged in a dispersed manner. For example, in the electrochromic element 1, a plurality of openings 41M may be formed in a predetermined/certain pattern in a single transparent conductive layer 41 formed on the upper surface of the second substrate 50. Thus, the plurality of electrically non-conductive areas 40N may be arranged in a dispersed manner. An area of the second electrode 40 other than the electrically non-conductive areas 40N may be an electrically conductive area 40C (e.g., second electrically conductive area). The area ratio of the electrically conductive area 40C in the second electrode 40 may be higher than the area ratio of the electrically conductive area 20C in the first electrode 20. Accordingly, the light-shielding properties of the electrochromic element 1A in the light-shielding state S1 may be maintained.

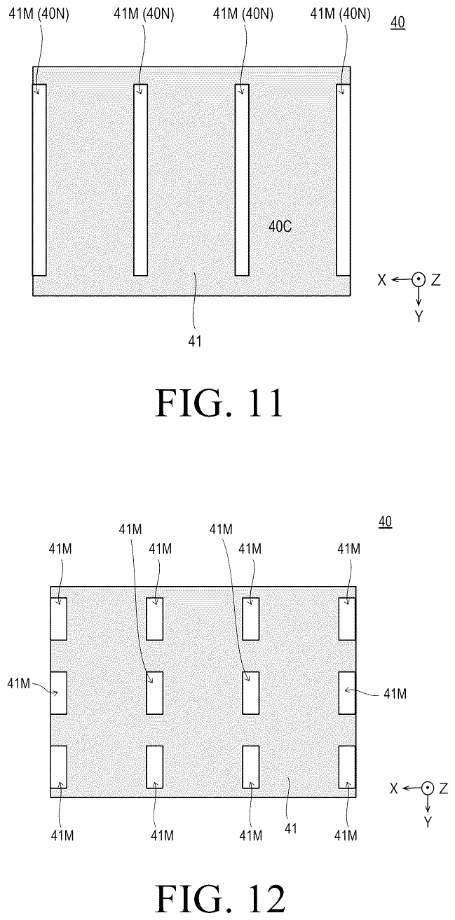

FIG. 11 illustrates an example of an arrangement of the plurality of openings 41M formed in the transparent conductive layer 41. The openings 41M may each have, for example, a rectangular planar shape (e.g., on the XY plane) extending in the second direction Y. The plurality of openings 41M may be arranged side by side in the first direction X. For example, the plurality of openings 41M may be each arranged in a stripe shape. In another example, the openings 41M may each have another planar shape such as an ellipse.

FIG. 12 illustrates another example of the arrangement of the plurality of openings 41M. The openings 41M may be arranged, for example, in a matrix shape. The openings 41M may each have, for example, a rectangular planar shape (e.g., on the XY plane) and may be arranged in a matrix shape in the first direction X and the second direction Y. The openings 41M may each have another planar shape such as a circle or a polygon.

In the electrochromic element 1A according to another embodiment, the first electrode 20 may have an electrically non-conductive area 20N. Accordingly, when switching from the light-shielding state S1 to the light-transmissive state S2, applying a larger oxidation voltage V2 may reduce the switching time t1 required for this change. For example, the second electrode 40 may have an electrically non-conductive area 40N. Accordingly, the film stress of the metal m deposited on the surface of the second electrode 40 may be relaxed. Thus, film peeling of the metal m on the surface of the second electrode 40 may be less likely to occur, and the light-shielding property may be maintained more stably. In particular, since film peeling of the metal m is less likely to occur on the surface of the second electrode 40 having a larger area than the first electrode 20, film peeling of the metal m may be suppressed more effectively.

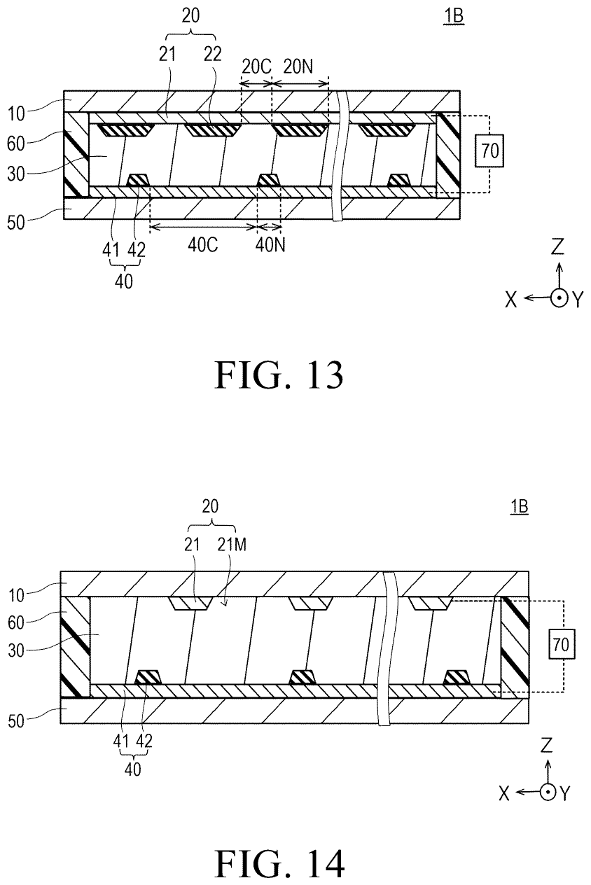

FIG. 13 illustrates an example of a cross-sectional configuration (e.g., XZ cross section) of an electrochromic element (e.g., electrochromic element 1B) according to another embodiment. FIG. 13 corresponds to FIG. 1 illustrating the electrochromic element 1 of the above embodiment. The first electrode 20 of this electrochromic element 1B may include an insulating layer 22 formed between the transparent conductive layer 21 and the electrolyte layer 30. The second electrode 40 may include an insulating layer 42 formed between the transparent conductive layer 41 and the electrolyte layer 30. Except for these aspects, the electrochromic element 1B according to another embodiment may have the same configuration as the electrochromic element 1 described in the above embodiment.

The insulating layer 22 may be selectively disposed in an electrically non-conductive area 20N of the first electrode 20. For example, the electrically non-conductive area 20N may be formed by the insulating layer 22. The first electrode 20 may include, for example, a plurality of insulating layers 22 disposed separately from each other. The insulating layer 22 may be formed of, for example, silicon nitride (SiN), silicon oxide (SiO₂), silicon oxynitride (SiO_{X}N_{Y}), an acrylic resin, an epoxy resin, or a polyimide resin. The insulating layer 22 may be, for example, a transparent insulating layer (e.g., the transparent conductive layer 21). The transparent conductive layer 21 may be formed, for example, over the entire lower surface of the first substrate 10. For example, the transparent conductive layer 21 may be formed as a so-called beta layer.

The insulating layer 42 may be selectively disposed in an electrically non-conductive area 40N of the second electrode 40. For example, an electrically non-conductive area 40N may be formed by the insulating layer 42. The second electrode 40 may include, for example, a plurality of insulating layers 42 arranged in an island shape. The insulating layers 42 may be formed of, for example, silicon nitride, silicon oxide (SiO₂), silicon oxynitride (SiO_{X}N_{Y}), an acrylic resin, an epoxy resin, or a polyimide resin. The insulating layers 42 may each be, for example, a transparent insulating layer similar to the transparent conductive layer 41. The transparent conductive layer 41 may be formed, for example, over the entire upper surface of the second substrate 50. For example, the transparent conductive layer 41 may be formed as a so-called beta layer.

In the electrochromic element 1B according to another embodiment, the first electrode 20 may have an electrically non-conductive area 20N. Accordingly, when switching from the light-shielding state S1 to the light-transmissive state S2, applying a larger oxidation voltage V2 may shorten or reduce the switching time t1 needed to change from the light-shielding state S1 to the light-transmissive state S2. For example, the electrically non-conductive area 20N of the first electrode 20 may be formed by the insulating layer 22, and the electrically non-conductive areas 40N of the second electrode 40 may be formed by the insulating layers 42. Accordingly, the transparent conductive layer 21 and the transparent conductive layer 41 may be formed as beta layers. Thus, an increase in resistance of the first electrode 20 and the second electrode 40 may be suppressed, and IR drop may be reduced. Therefore, the time required for switching between the light-shielding state S1 and the light-transmissive state S2 may be further shortened.

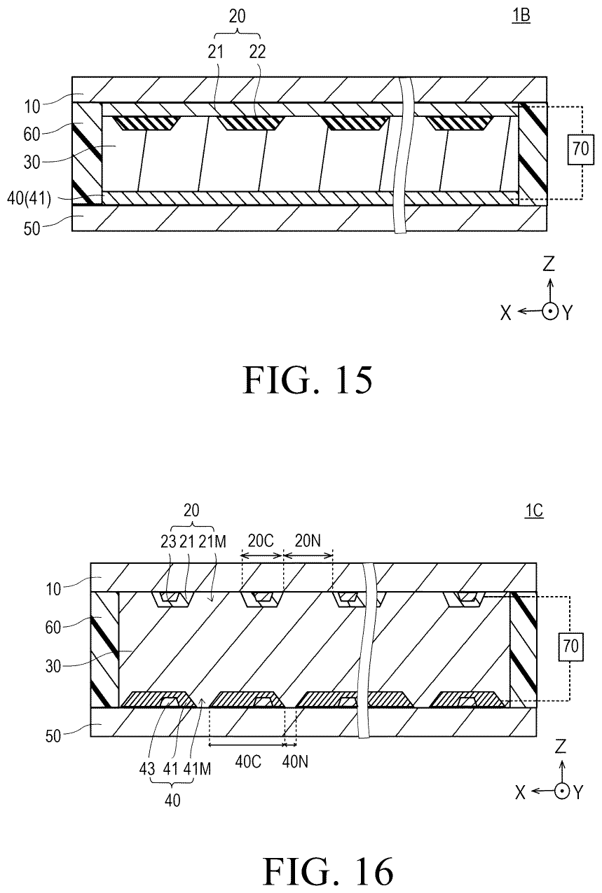

FIGS. 14 and 15 illustrate other examples of the electrochromic element 1B. In the electrochromic element 1B, the first electrode 20 may not include the insulating layer 22. For example, an electrically non-conductive area 20N of the first electrode 20 may be formed, for example, by an opening 21M of the transparent conductive layer 21 (see, e.g., FIG. 14). In another example, in the electrochromic element 1B, the second electrode 40 may not have the insulating layer 42. For example, the electrically non-conductive area 40N of the second electrode 40 may be formed, for example, by an opening 41M of the transparent conductive layer 41. The second electrode 40 may not have the electrically non-conductive area 40N (see, e.g., FIG. 15).

FIG. 16 illustrates an example of a cross-sectional configuration (e.g., XZ cross section) of an electrochromic element (e.g., electrochromic element 1C) according to another embodiment. FIG. 16 corresponds to FIG. 1 illustrating the electrochromic element 1 of the above embodiment. The first electrode 20 of this electrochromic element 1C may include a low-resistance conductive layer 23 (e.g., first low-resistance conductive layer) laminated on the transparent conductive layer 21. The second electrode 40 may include a low-resistance conductive layer 43 (e.g., second low-resistance conductive layer) laminated on the transparent conductive layer 41. Except for these aspects, the electrochromic element 1C according to another embodiment may have the same configuration as the electrochromic element 1A.

The low-resistance conductive layer 23 may have a resistivity lower than that of the transparent conductive layer 21. The low-resistance conductive layer 23 may have, for example, a light transmittance lower than that of the transparent conductive layer 21. The low-resistance conductive layer 23 may include, for example, at least one of aluminum (Al), an aluminum alloy, silver (Ag), a silver alloy, molybdenum (Mo), a molybdenum alloy, copper (Cu), copper oxide (CuO), a copper alloy, chromium (Cr), and nickel (Ni). The first electrode 20 may include a laminated low-resistance conductive layer 23. For example, the laminated low-resistance conductive layer 23 may include two blackened layers and a wiring layer formed between the blackened layers. The blackened layers may each include, for example, chromium, nickel plating, or copper oxide. The wiring layer may include copper or a copper alloy. Since the first electrode 20 has the low-resistance conductive layer 23 including the blackened layers, external light reflection caused by the low-resistance conductive layer 23 may be suppressed, thereby improving the visibility of the display device 100.

The low-resistance conductive layer 23 may be disposed, for example, on at least a portion of the electrically conductive area 20C. For example, the low-resistance conductive layer 23 may be disposed excluding the electrically non-conductive area 20N. Accordingly, degradation of light transmittance due to the low-resistance conductive layer 23 may be suppressed.

The first electrode 20 may include, for example, the low-resistance conductive layer 23 and the transparent conductive layer 21 in this order from a lower surface of the first substrate 10. In another example, the first electrode 20 may include the transparent conductive layer 21 and the low-resistance conductive layer 23 in this order from the lower surface of the first substrate 10. However, in this structure, since the low-resistance conductive layer 23 is in direct contact with the electrolyte layer 30, it may be sufficient to use a material having a lower ionization tendency than the metal m or the mediator, such as Au or Pt, so that the low-resistance conductive layer 23 may not be dissolved in the electrolyte layer 30, or although the low-resistance conductive layer 23 has a higher ionization tendency than the metal m or the mediator, to form a protective layer, such as silicon nitride, silicon oxide (SiO₂), silicon oxynitride (SiO_{X}N_{Y}), an acrylic resin, an epoxy resin, or a polyimide resin, so as to cover at least the low-resistance conductive layer 23.

The low-resistance conductive layer 43 may have a resistivity lower than that of the transparent conductive layer 41. The low-resistance conductive layer 43 may be a conductive layer having, for example, a light transmittance lower than that of the transparent conductive layer 41. The low-resistance conductive layer 43 may include, for example, at least one of aluminum (Al), an aluminum alloy, silver (Ag), a silver alloy, molybdenum (Mo), a molybdenum alloy, copper (Cu), copper oxide (CuO), a copper alloy, chromium (Cr), and nickel (Ni). The second electrode 40 may include a laminated low-resistance conductive layer 43. For example, the laminated low-resistance conductive layer 43 may include two blackened layers and a wiring layer formed between the blackened layers. The blackened layers may each include, for example, chromium, nickel plating, or copper oxide. The wiring layer may include copper or a copper alloy. Since the second electrode 40 has the low-resistance conductive layer 43 including the blackened layers, external light reflection caused by the low-resistance conductive layer 43 may be suppressed, thereby improving the visibility of the display device 100.

At least a portion of the low-resistance conductive layer 43 may be disposed at a position opposite to the low-resistance conductive layer 23 and may be disposed at a position overlapping the electrically conductive area 20C when viewed on a plane (e.g., XY plane) or in plan view. The low-resistance conductive layer 43 may be disposed at a position that does not overlap the electrically non-conductive area 20N when viewed on the plane (or in plan view). Accordingly, degradation of light transmittance due to the low-resistance conductive layer 43 may be suppressed.

The second electrode 40 may include, for example, the low-resistance conductive layer 43 and the transparent conductive layer 41 in this order from an upper surface of the second substrate 50. In another example, the second electrode 40 may include the transparent conductive layer 41 and the low-resistance conductive layer 43 in this order from the upper surface of the second substrate 50. However, in this structure, since the low-resistance conductive layer 23 is in direct contact with the electrolyte layer 30, it may be sufficient to use a material having a lower ionization tendency than the metal m or the mediator, such as Au or Pt, so that the low-resistance conductive layer 23 may not be dissolved in the electrolyte layer 30, or although the low-resistance conductive layer 23 has a higher ionization tendency than the metal m or the mediator, to form a protective layer, such as silicon nitride, silicon oxide (SiO₂), silicon oxynitride (SiO_{X}N_{Y}), an acrylic resin, an epoxy resin, or a polyimide resin, so as to cover at least the low-resistance conductive layer 23.

In the electrochromic element 1C according to another embodiment, the first electrode 20 may have an electrically non-conductive area 20N. Accordingly, when switching from the light-shielding state S1 to the light-transmissive state S2, applying a larger oxidation voltage V2 may shorten or reduce the switching time t1 needed to change from the light-shielding state S1 to the light-transmissive state S2. For example, the first electrode 20 may include the low-resistance conductive layer 23 having a lower resistivity than the transparent conductive layer 21, and the second electrode 40 may include the low-resistance conductive layer 43 having a lower resistivity than the transparent conductive layer 41. Accordingly, an increase in resistance of the first electrode 20 and the second electrode 40 may be suppressed, and IR drop may be reduced. Therefore, the time required for switching between the light-shielding state S1 and the light-transmissive state S2 may be further shortened.

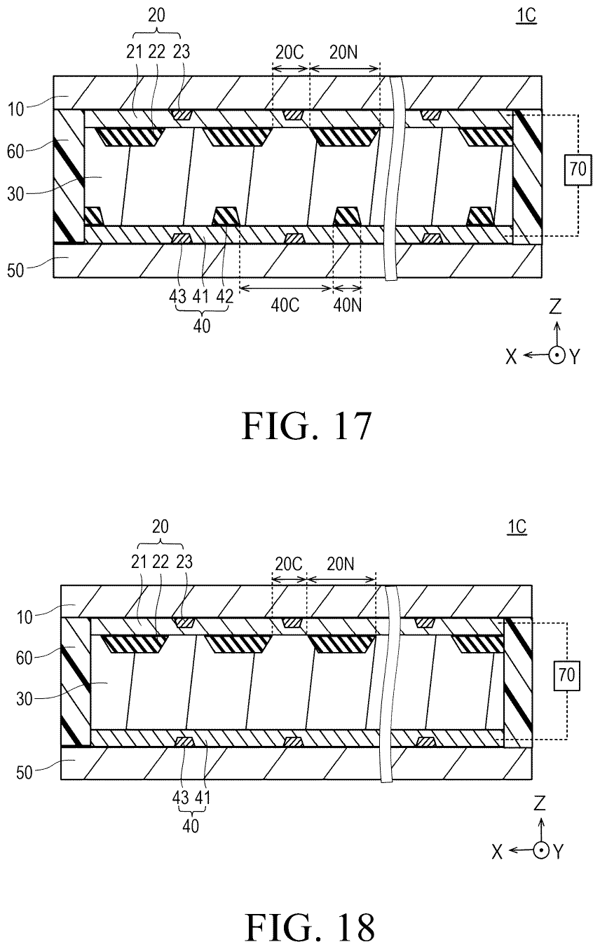

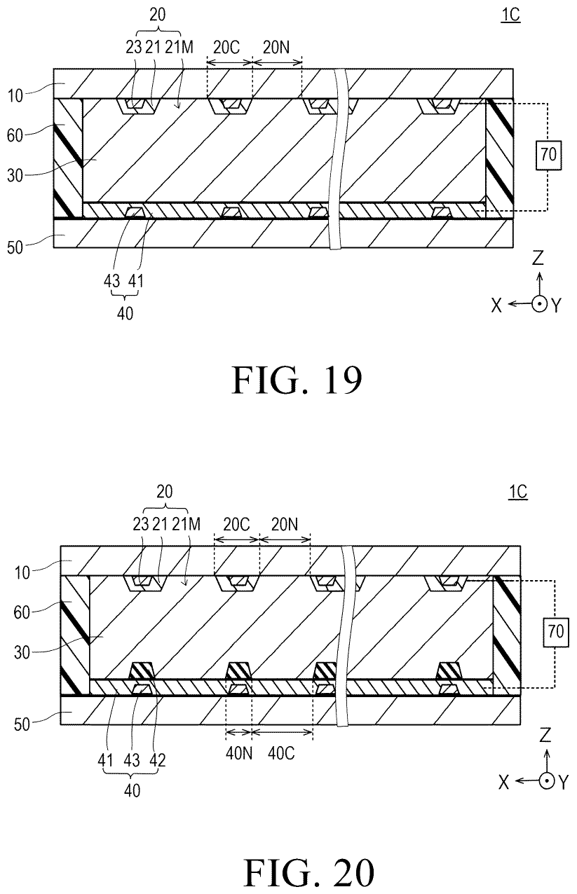

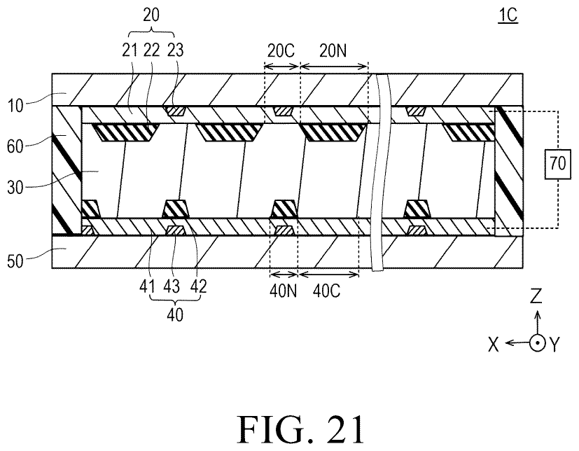

FIGS. 17 to 21 illustrate other examples of the electrochromic element 1C. In the electrochromic element 1C, the electrically non-conductive area 20N of the first electrode 20 may be formed of an insulating layer 22, and the electrically non-conductive area 40N of the second electrode 40 may be formed of an insulating layer 42 (see, e.g., FIG. 17). The second electrode 40 may not have the electrically non-conductive area 40N (see, e.g., FIGS. 18 and 19). The electrically non-conductive area 20N of the first electrode 20 may be formed of an opening 21M of the transparent conductive layer 21, and the electrically non-conductive area 40N of the second electrode 40 may be formed of the insulating layer 42 (see, e.g., FIG. 20). The electrically non-conductive area 20N of the first electrode 20 may be formed of the insulating layer 22, and the electrically non-conductive area 40N of the second electrode 40 may be formed of an opening 41M of the transparent conductive layer 41. The low-resistance conductive layer 43 may be disposed at a position displaced from the insulating layer 42 (see, e.g., FIG. 17), or may be disposed at a position overlapping the insulating layer 42 (see, e.g., FIG. 21).

The above-described configurations of the display devices 100 having the electrochromic element 1, 1A, 1B, and 1C are described as major configurations for explaining the features of the above embodiment, and are not limited to the above-described configurations but may be variously modified within the scope of the claims. For example, it may not be intended to exclude configurations generally disposed in a display device.

For example, in the above-described embodiment, an example has been described in which the surface of the second electrode 40 is a flat surface, but the surface of the second electrode 40 may be an uneven surface. The uneven surface may be formed, for example, by fine particles such as ITO or antimony-doped tin oxide (ATO). When the surface of the second electrode 40 is an uneven surface, in the light-shielding state S1 of the electrochromic element 1, plasmon absorption and scattering of visible light occur due to the deposited metal m, thereby forming a black surface on the surface of the second electrode 40.

For example, in the above-described embodiment, an example has been described in which an oxidation voltage V2 is applied between the first electrode 20 and the second electrode 40 when switching from the light-shielding state S1 to the light-transmissive state S2. However, the voltage applicator 70 may apply a voltage having a magnitude smaller than the oxidation voltage V2 between the first electrode 20 and the second electrode 40 when switching from the light-shielding state S1 to the light-transmissive state S2.

For example, in the above-described embodiment, an example has been described in which the electrochromic elements 1, 1A, 1B, and 1C each have a single first electrode 20 connected to a first electric potential and a single second electrode 40 connected to a second electric potential. However, the electrochromic elements 1, 1A, 1B, and 1C may each have a plurality of first electrodes 20 and a plurality of second electrodes 40, each having an electrically non-conductive area. For example, the first electrode 20 may be electrically divided, and the second electrode 40 may be electrically divided. Accordingly, in each of the electrochromic elements 1, 1A, 1B, and 1C, the light-shielding state S1 and the light-transmissive state S2 may be switched partially.

For example, in the above-described embodiment, an example in which the light-emitting element 92 is formed as a micro-LED has been described, but the light-emitting element 92 may be formed as an LED larger than a micro-LED, for example, a mini-LED or a general LED having a size with a diameter of 100 μm or more. The light-emitting element 92 may also be formed as another light-emitting element such as an organic light-emitting diode (OLED) or an inorganic EL element. The transparent display 2 may also include a display element other than a light-emitting element, and the transparent display 2 may be a liquid crystal display using a liquid crystal layer or the like.

In the above-described embodiment, an example has been described in which light in the red wavelength area, light in the green wavelength area, and light in the blue wavelength area are emitted from the transparent display 2, but the wavelength area of the light emitted from the transparent display 2 is not limited thereto.

What is claimed is:

1. An electrochromic element comprising:
a first electrode comprising a first electrically conductive area and at least one first electrically non-conductive area, the first electrode being connected to a first electric potential;
a second electrode opposite to the first electrode, the second electrode comprising a second electrically conductive area having an area ratio greater than an area ratio of the first electrically conductive area in the first electrode; and
an electrolyte layer between the first electrode and the second electrode, the electrolyte layer comprising an electrochromic material.

2. The electrochromic element of claim 1, wherein the second electrode further comprises a second electrically non-conductive area and is connected to a second electric potential.

3. The electrochromic element of claim 1, wherein the at least one first electrically non-conductive area comprises a plurality of first electrically non-conductive areas arranged in a pattern on the first electrode.

4. The electrochromic element of claim 1, wherein the first electrode comprises a first transparent conductive layer, and
wherein the second electrode comprises a second transparent conductive layer.

5. The electrochromic element of claim 4, wherein the first electrode further comprises an insulating layer between the first transparent conductive layer and the electrolyte layer and arranged in the at least one first electrically non-conductive area.

6. The electrochromic element of claim 4, wherein the first transparent conductive layer has an opening in the at least one first electrically non-conductive area.

7. The electrochromic element of claim 4, wherein the first electrode further comprises a first low-resistance conductive layer, and
wherein the first low-resistance conductive layer is on the first transparent conductive layer and has a lower resistivity than the first transparent conductive layer.

8. The electrochromic element of claim 7, wherein the first low-resistance conductive layer is on at least a portion of the first electrically conductive area.

9. The electrochromic element of claim 7, wherein the second electrode further comprises a second low-resistance conductive layer, and
wherein the second low-resistance conductive layer is on the second transparent conductive layer and has a resistivity that is lower than a resistivity of the second transparent conductive layer, and
wherein at least a portion of the second low-resistance conductive layer is at a position opposite to the first low-resistance conductive layer.

10. The electrochromic element of claim 4, wherein at least one of the first transparent conductive layer and the second transparent conductive layer is a continuous layer.

11. The electrochromic element of claim 1, wherein the electrochromic material is configured to switch between a light-shielding state, in which the electrochromic material is deposited on a surface of the second electrode, and a light-transmissive state, in which the electrochromic material is dissolved in the electrolyte layer.

12. The electrochromic element of claim 11, further comprising:
a voltage applicator configured to apply a voltage between the first electrode and the second electrode to switch between the light-shielding state and the light-transmissive state.

13. The electrochromic element of claim 12, wherein the voltage applicator is configured to apply the voltage having a same magnitude and opposite polarities when switching from the light-shielding state to the light-transmissive state and when switching from the light-transmissive state to the light-shielding state.

14. A display device comprising:
an electrochromic element comprising:
a first electrode comprising a first electrically conductive area and at least one first electrically non-conductive area, the first electrode being connected to a first electric potential;
a second electrode opposite to the first electrode, the second electrode comprising a second electrically conductive area having an area ratio higher than an area ratio of the first electrically conductive area in the first electrode; and
an electrolyte layer between the first electrode and the second electrode, the electrolyte layer comprising an electrochromic material; and
a transparent display on the electrochromic element and comprising a light-transmissive area and a light-shielding area.

15. The display device of claim 14, wherein at least a portion of the first electrically conductive area is at a position overlapping the light-shielding area.

16. The display device of claim 14, wherein the electrochromic element is configured to switch the transparent display between a high-contrast display mode and a high-transmittance display mode.

17. The display device of claim 14, further comprising a voltage applicator configured to adjust the electric potential difference between the first electrode and the second electrode.

18. The display device of claim 14, wherein the second electrode further comprises a second electrically non-conductive area and is connected to a second electric potential.

19. The display device of claim 14, wherein a plurality of first electrically non-conductive areas are arranged in a certain pattern on the first electrode.

20. A method of controlling an electrochromic element, the method comprising:
applying a reduction voltage between a first electrode and a second electrode of the electrochromic element such that an electrochromic material is deposited on a surface of the second electrode o have a light-shielding state; and
applying a oxidation voltage between the first electrode and the second electrode of the electrochromic element to dissolve the electrochromic material to switch to a light-transmissive state.
